(19) United States
(12) Patent Application Publication
(10) Pub. No.: US 2012/0020697 A1
(43) Pub. Date: Jan. 26, 2012

(54) METHOD OF FIXING A HEAT CURABLE TONER TO A CARRIER

(76) Inventors: Eric Carl Stelter, Pittsford, NY (US); Dinesh Tyagi, Fairport, NY (US); James H. Hurst, Rochester, NY (US); Domingo Rohde, Kiel (DE); Knut Behnke, Flintbeck (DE); Detlef Schulze-Hagenest, Molfsee (DE)

(21) Appl. No.: 13/133,389

(22) PCT Filed: Dec. 9, 2008
(86) PCT No.: PCT/EP2008/010438

§ 371 Date: Oct. 14, 2011

(51) Int. Cl. G03G 21/20; G03G 13/20; G03G 15/20

(52) U.S. Cl. 399/94; 399/336

(57) ABSTRACT

A method and an apparatus of fixing a heat curable toner to a carrier substrate are shown. In the method, a toner applied to a first surface of the carrier substrate is heated above the glass transition temperature of the toner by microwave radiation, using at least one microwave applicator as a first heat source, to thereby initiate thermal cross-linking of polymer chains of said toner. The temperature is kept above the glass transition temperature of the toner for a predetermined time of at least one second, by applying heat to the toner by means of at least one non-contact second heat source, to thereby allow the thermal cross-linking to proceed further and to thereby raise the glass transition temperature of the toner. The apparatus has at least one microwave applicator forming a first heat source, at least one second heat source for heating the toner and/or the carrier substrate, at least one transport mechanism for contacting the carrier substrate on a second side thereof and for transporting the carrier substrate in sequence along the first and second heat sources and at least one controller for controlling the first heat source, the second heat source and/or the transport mechanism such that toner on a first side of the carrier substrate is heated above its glass transition temperature and kept at a temperature above the glass transition temperature for at least one second.

The present invention relates to a method of fixing a heat curable toner to a carrier substrate and a method of double-sided printing on a carrier substrate.

In the print industry, it is known to apply toner particles to a carrier substrate, for example by an electro-photographic printing process. After the application of the toner particles, the loosely adhering particles are fused to the carrier substrate, typically by heating the toner particles above their glass transition temperature. In this “molten” state, the toner intimately bonds to the surface of the substrate. This may for example be achieved by fusing rollers, which directly contact the toner particles and apply heat and pressure thereto, to thereby fuse the particles to the carrier substrate. In order to avoid toner particles to adhere to the fusing rollers, it is known to use oil on the fusing rollers, which oil may also be at least partially transferred to the carrier substrate. Such oil may, however, be detrimental to the further processing of the carrier substrate, in particular in double-sided printing thereof.

It is also known to heat the toner particles above their glass transition temperature by a non-contact method, such as by microwave radiation, or by infrared radiation. Even though this method is typically satisfactory for single-sided printing on a carrier substrate, paper-handling during the heat application step may be troublesome when double-sided printing on the carrier substrate is used. The reason therefore being that the carrier substrate, when fixing the toner particles on the second side of the carrier substrate, will also heat the toner particles fixed to the first side of the carrier substrate. Thus, the toner will be in a nearly liquid state on both sides of the carrier substrate, causing problems with the handling system contacting the carrier substrate.

In view of this problem one approach used a staggered system of for example microwave heating, cooling and substrate transport, in which the carrier substrate and the toner particles are only heated in areas, where there is no contact between a handling system and the back side of the carrier substrate, i.e. the side facing away from the currently fused toner. Such a staggered system, however, has a potential for image artifacts and substrate handling difficulties.

Another approach to allow non-contact fixing of toner particles to carrier substrate has been the use of UV curable toners, which during the fixing step were heated above their glass transition temperature, for example by infrared radiation and were subsequently irradiated with UV-radiation, to at least partially cure the toner particles. The curing of the toner particles leads to a cross-linking of polymer chains within the toner, which leads to an increase of the glass transition temperature and the melt elasticity of the toner. A toner formulation capable of being UV curable must have photo initiator chemicals added thereto, and during the fixing step UV-radiation has to be applied to the toner, which may cause several problems.

In view of the different approaches mentioned above, it is an object of the present invention to overcome one or more of the defects of the art.

This object is solved by a method of fixing a heat curable toner to a carrier substrate, wherein the substrate and the toner is heated above the glass transition temperature of the toner (i.e. melted) by microwave radiation using at least one microwave applicator as a first heat source, to thereby initiate thermal cross-linking of polymer chains of said toner. The temperature is kept above the glass transition temperature of the toner for a predetermined time of at least 1 second by applying heat to the toner by means of at least one second heat source, to thereby allow the thermal cross-linking to proceed further and to thereby raise the glass transition temperature and the melt elasticity of the toner. Rather than using a specific toner having photo initiator chemicals, the present invention uses separate heat sources, to keep a heat curable toner above a glass transition temperature of the toner to thereby raise the glass transition temperature. Raising the glass transition temperature and the melt elasticity leads to the advantage that in double-sided printing a toner which is applied to a first side of a carrier substrate and then cured is not remelted or at least only partially melted during a second path through a fuser, i.e. when toner is fixed to a second side of the carrier substrate.

In accordance with one embodiment, the at least one second heat source is a non-contact heat source, thereby avoiding any potential problems associated with contact heat sources. Such a non-contact heat source may for example be a microwave applicator, an IR-radiator, an oven chamber or a source of hot air.

In accordance with another embodiment of the invention, the toner may additionally be UV-curable, and while the toner is kept at a temperature above its glass transition temperature, it is irradiated with UV-radiation. Having a combined heat curable and UV-curable toner may speedup the cross-linking reaction and may lead to a higher glass transition temperature within a short time, compared to an only heat curable toner. When a UV-curable toner is used, the UV-radiation may be provided by a source of radiation which also provides infrared radiation, to keep the temperature of the toner above its glass transition temperature while irradiating the same with UV-radiation.

In accordance with one embodiment, a second surface of the carrier substrate may be cooled, while the toner applied to the first surface of the carrier substrate is kept above its glass transition temperature. Cooling the second surface of the carrier substrate allows the use of higher temperatures to be used for heating the toner applied to the first side of the carrier substrate. Also, cooling the second side of the carrier substrate is particularly advantageous in double sided printing, as any toner fixed to the second side of the carrier substrate may be sufficiently cooled not to be raised above its glass transition temperature. In order to allow a controlled continuous transport of the carrier substrate during the above method, it may be transported along the first and second heat sources by a transport belt contacting a second surface of the carrier substrate. In one embodiment, cooling of the second surface of the carrier substrate is provided via the transport belt, which is in contact with the second side of the carrier substrate and may thus provide cooling by conducting heat away. Cooling of the second surface of the carrier substrate may be provided by blowing a cooling gas onto the second surface of the carrier substrate and/or onto parts of the transport belt. The cooling gas may be blown onto the second surface of the carrier substrate and/or the transport belt in an area opposite the first and/or second heat source, thus providing localized cooling where it is most needed. For cost reasons, the cooling gas is preferably air. The air may be conditioned prior to being blown onto the second surface of the carrier substrate and/or the transport belt. Conditioning may for example include cooling, filtering, drying the air and/or additional steps.

The above object is also achieved by a method of double-sided printing on a carrier substrate, wherein a heat curable toner is applied to a first side of the carrier substrate and the toner is fixed to the first side of the carrier substrate in accordance with the above method, thereby raising the glass transition temperature of the toner on the first side to a higher temperature value. Then, a heat curable toner is applied on a second side of the carrier substrate and the toner is fixed to the second side of the carrier substrate in accordance with the above method, wherein the toner fixed to the first side of the carrier substrate is in substance not heated above its glass transition temperature. The term in substance means that less than 50%, preferably less than 80% of the toner is raised above its glass transition temperature. This method enables conventional paper transport mechanisms to be used, inasmuch as the toner and carrier substrate on the first side of the carrier substrate may be in contact with the transport mechanism even during the fixing step used to fix the toner on the second side of the carrier substrate.

The above may for example be achieved by keeping the temperature used in the second fixing step below the temperature value of the raised glass transition temperature of the toner on the first side. Alternatively or additionally, the toner on the first side of the carrier substrate may be cooled during the second fixing step by the means described above.

The above object is also achieved by an apparatus for fixing a heat curable toner to a carrier substrate comprising at least one microwave applicator forming a first heat source, at least one second heat source for heating the toner and/or the carrier substrate, at least one transport mechanism for contacting the carrier substrate on a second side thereof and for transporting the carrier substrate in sequence along the first and second heat sources and at least one controller for controlling the first heat source, the second heat source and/or the transport mechanism such that toner on a first side of the carrier substrate is heated above its glass transition temperature and kept at a temperature above the glass transition temperature for at least one second. Such an apparatus is capable of achieving the advantages already described with respect to the method described above.

Preferably, the at least one second heat source is a non-contact heat source. In accordance with the invention, the at least one second heat source may comprise one or more of the following: a microwave applicator, a source of IR-radiation, an oven chamber, a source of hot air.

A source of UV-radiation may be provided in the vicinity of or may be integrated within the second heat source. The source of UV-radiation may also provide IR-radiation.

In one embodiment, means for cooling the second side of the carrier substrate are provided. The transport mechanism may comprise a transport belt contacting the second side of the carrier substrate, and the cooling means may be arranged to cool the transport belt. The cooling means may comprise a source of a cooling gas and may be arranged to blow the cooling gas onto the second side of the carrier substrate and/or onto parts of the transport belt. In accordance with a specific embodiment, the cooling means are arranged to blow the cooling gas onto the second surface of the carrier substrate and/or the transport belt in an area opposite the first/and or second heat source. The cooling means may comprise means for conditioning the gas prior to being blown onto the second surface of the carrier substrate and/or the transport belt.

The invention will be described in more detail herein below with reference to the drawings, in the drawings:

### BRIEF DESCRIPTION OF THE DRAWINGS

FIG. 1 is a schematic side view of part of an electrophotographic printing apparatus;

FIG. 2 is a schematic side view of a fuser arrangement;

FIG. 3 is a temperature-time-diagram of a conventional method for fusing a heat curable toner to a carrier sheet;

FIG. 4 is a temperature-time-diagram of a method for fusing a heat curable toner to a carrier sheet in accordance with an exemplary embodiment; and

FIG. 5 is a temperature-time-diagram of a method for fusing a heat curable toner to a carrier sheet in accordance with an exemplary embodiment which may be used in duplex printing.

### DESCRIPTION OF PREFERRED EMBODIMENTS

The following description uses relative terms such as left, right, above and below which relative terms refer to the drawings and should not be construed to limit the application.

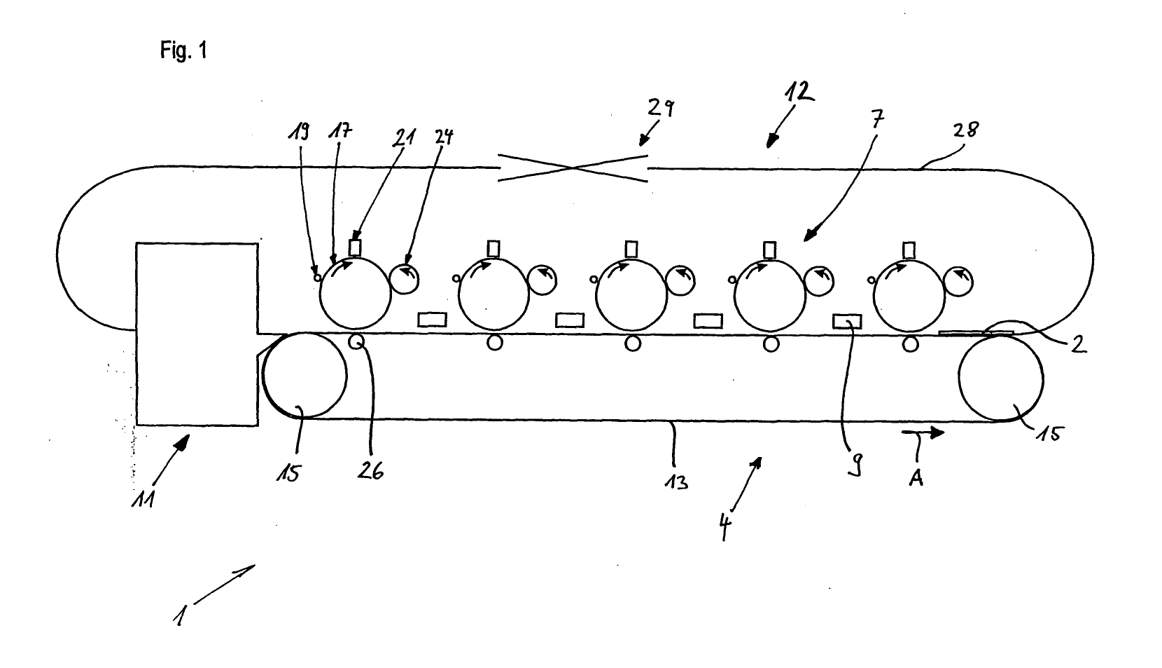

FIG. 1 illustrates a schematic side view of an electrophotographic printing apparatus 1, for printing onto a substrate 2, such as for example paper, packaging board, adhesive tags or any other suitable substrate. The printing apparatus 1 as shown has a first substrate transport arrangement 4, print modules 7, charge neutralizing devices 9, a fuser arrangement 11 and a second transport arrangement 12. A Substrate feeder (not shown) may be provided on the right side, for feeding substrates into the apparatus 1 and similarly on the left side, a substrate tray (not shown) may be provided for substrates coming out of the apparatus 1.

The first substrate transport arrangement 4 is made of a transport belt 13, which is entrained about two rollers 15, at least one of which is coupled to a drive mechanism (not shown) to move the transport belt 13 in a circular path around the rollers 15, as indicated by arrow A. The transport belt 13 is arranged to transport the substrate to be printed through the print modules 7.

Five print modules 7 are shown allowing a multi color print using for example cyan, magenta, yellow and carbon (black) plus one additional color. Each print module 7 has a photoconductor drum 17, a charge device 19, such as a corona or roller charging device, a selective discharge device 21, a toner application device 24 and a transfer roller 26. The transfer roller is arranged below the photoconductor drum 17, such that a nip is formed therebetween through which the transport belt 13 and substrate 2 may pass, while ensuring that the substrate 2 is pressed against the photoconductor drum. Suitable toner application devices are for example described in U.S. Pat. No. 4,546,060 and US 2006/0177240.

The four charge neutralizing devices 9 are provided, one each between the print modules 7. The charge neutralizing devices may be any device capable of discharging a substrate passing there under, such as a passive element like metallic hair bushes or an active discharge device e.g. a corona device such as a corotron or a scorotron. Also a calendar roller or a pressure roller may be used for discharging toner applied to the surface of the substrate 2.

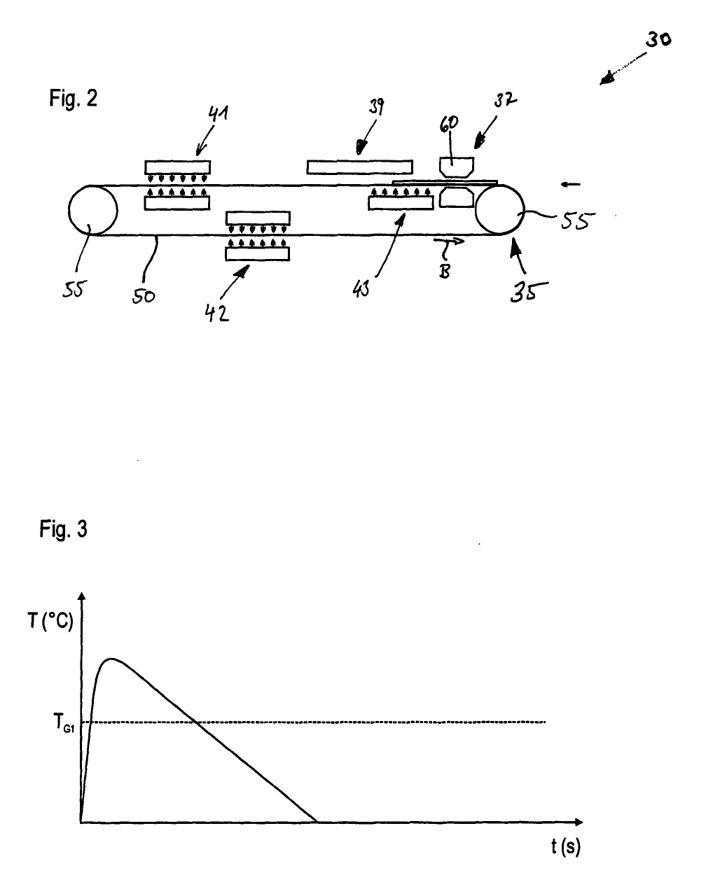

The fuser apparatus 11 is arranged at the downstream end of the transport arrangement 4, and has an internal transport arrangement for transporting a substrate 2, which is transferred from the transport arrangement 4 through the fuser apparatus 11. As will be described in more detail herein below with reference to FIG. 2, the fuser apparatus 11 is a non-contact fusing apparatus in which the upper surface thereof i.e. the surface onto which the toner has just been applied is not contacted during the fusing process.

The second transport arrangement 12 may be of any type providing a duplex path for returning a substrate 2 from a downstream end of the fuser apparatus 11 to the upstream end of the first transport arrangement 4. The second transport arrangement has an inverter 29 for inverting the substrate 2 in the duplex path such that it is delivered to the upstream end of the first transport arrangement 4 in an inverted manner, as is known in the art.

FIG. 2 illustrates a schematic side view of an exemplary fuser arrangement 30 which may be used inside fuser apparatus 11 of FIG. 1. The fuser arrangement 30 has an internal transport arrangement 35, a first heat source 37, a second heat source 39, a first cooling arrangement 41, a second cooling arrangement 42 and a third cooling arrangement 43.

The substrate transport arrangement 35 is made of a transport belt 50, which is entrained about two rollers 55, at least one of which is coupled to a drive mechanism (not shown) to move the transport belt 55 in a circular path around the rollers 55, as indicated by arrow B. The transport belt 50 is arranged to transport a substrate 2 along the first and second heat sources 37, 39 and along the first and third cooling arrangements 41, 43, respectively. The transport belt thereby defines a straight transport path for the carrier substrate 2. The transport belt 50 may be any suitable type of belt, which preferably has a low absorption rate for microwave radiation. The transport belt 50 may for example be a perforated belt which allows it to be used as a suction type belt, in which case a suctioning mechanism (not shown) may be arranged adjacent to at least portions of an inside surface of the transport belt 50.

The first heat source 37 is formed by at least one microwave applicator 60. As shown the microwave applicator is formed of two spaced elements, which form a resonant cavity for microwaves. The two elements are arranged such that the transport belt 55 extends through the space formed there between. The transport belt 55 is thus capable of transporting a carrier substrate 2 having toner thereon through the space between the two elements of the microwave applicator, as indicated in FIG. 2.

The second heat source 39 is arranged downstream (considering the direction of transport of the transport arrangement 35) with respect to the first heat source 37. The second heat source 39 is capable of supplying heat to the carrier substrate placed on the transport belt 50 in a non contact manner. The second heat source is shown elongated thereby indicating that heat may be supplied to the carrier substrate over an extended period of time, depending on the speed of the transport belt 50 transporting the substrate along the second heat source. Such a non-contact heat source may for example be a microwave applicator, an IR-radiator, an oven chamber or a source of hot air. In the case that the toner is not only heat curable but also UV-curable, a source of UV-radiation may be provided in the vicinity of or in the second heat source 39. Thus, the toner may be simultaneously heated and irradiated with UV-radiation. The source of UV-radiation may be provided by a source of radiation, which also provides infrared radiation and thus simultaneously acts as the second heat source 39 and the source of UV-radiation.

The second heat source 39 is shown as being arranged opposite the transport belt 50 such that heat is supplied to the carrier substrate 2 from the top side only. It is, however possible, that the second heat source is arranged to surround or sandwich the transport belt 50 and the carrier sheet, such that heat is supplied to the carrier substrate from both sides. In one embodiment, heating elements on opposite sides of the transport belt and carrier sheet may be individually controlled, as will be described in more detail herein below.

The first cooling arrangement 41 is arranged downstream (considering the direction of transport of the transport arrangement 35) with respect to the second heat source 39. The first cooling arrangement is capable of cooling the transport belt 50 and the carrier substrate placed thereon. The first cooling cooling arrangement may for example be formed by two gas blower arrangements capable of blowing a cooling gas onto opposite sides of the carrier belt 50 and the carrier substrate placed thereon. It is also possible to provide only a single gas blower arrangement adjacent the second heat source 39 and directed onto the outside surface of the transport belt 50 and the substrate carrier.

The second cooling arrangement 42 is arranged downstream (considering the direction of transport of the transport arrangement 35) with respect to the first cooling arrangement 41. The second cooling arrangement 42 is capable of cooling the transport belt 50 at a location remote from the straight transport path for the carrier substrate. The second cooling arrangement 42 may for example again be formed by two gas blower arrangements capable of blowing a cooling gas, onto opposite sides of the transport belt. It is also possible to provide only a single gas blower arrangement directed onto the outside or inside surface of the transport belt 50.

The third cooling arrangement 43 is arranged opposite the second heat source 39. The third cooling arrangement 43 is capable of cooling the transport belt 50 and or the side of the carrier substrate 2 contacting the transport belt 50. The third cooling arrangement 43 may be formed by a gas blower arranged to blow a cooling gas onto an inside surface of the transport belt 50 and thus in the case of a perforated belt onto parts of the side of the carrier substrate 2 contacting the transport belt 50. The cooling gas used by each of the cooling arrangements may be air such as the ambient air surrounding the fuser arrangement 30. A conditioner (not shown) may be provided for the first 41, second 42 and/or third 43 cooling arrangement to condition the gas prior to being blown towards the transport belt 50 or carrier substrate 2. Conditioning may for example encompass cooling, filtering, drying or other steps, to achieve preferably constant gas conditions over an extended period of time.

In case a suctioning mechanism is used to suck the carrier substrate to the transport belt, any gas blower arrangement located adjacent an inside of the transport belt should be arranged not to interfere with the suctioning mechanism. This may for example be achieved by a staggered or alternating arrangement of the suctioning mechanism and the blower arrangement.

Even thought the cooling arrangements are shown as gas blower arrangement, they can also be formed by other means such as cooling rollers contacting the transport belt and/or the carrier substrate. Also, not all of the cooling arrangements have to be provided. Especially the second cooling arrangement may be dispensed with if the third one is present and vice versa.

The apparatus comprises at least one appropriate controller (not shown) for controlling operation of the individual components such as the transport mechanism 35, the heat source 37 and 39, as well as the cooling arrangements 41 to 43.

Operation of the fuser arrangement 30 shown in FIG. 2 will now be described herein below with reference to specific examples and also FIGS. 3 to 5.

FIGS. 3 to 5 are each temperature-time-diagrams showing the temperature of a toner applied to the first side (i.e. the side not contacting the transport belt 50) of a carrier substrate 2 along a straight line perpendicular to its direction of transport, while it is moved through the fuser arrangement 30.

FIG. 3 is considered to show a conventional temperature time diagram used in fixing a toner to a carrier substrate. As shown, the toner is quickly raised above its glass transition temperature by a first heat source such as for example heated pressure rollers as described above. After passing the first heat source, the temperature falls quickly below the glass transition temperature and thus, only a small amount of thermal cross-linking—if any—occurs within the toner. If UV-radiation is used in combination with a UV-curable toner, a larger amount of cross-linking may be achieved in the short time the toner is at a temperature above its glass transition temperature.

In accordance with the present invention a heat curable toner as well as toner which is both curable by heat and UV-radiation may be used. Both alternatives are just referred to as heat curable toner. The heat curable toner may for example have a first (initial) glass transformation temperature T_{G1} in a range from 45° C. to 75° C. prior to the curing process described below. The toner may be a powdery dry toner having polymer chains which form cross-links when heated above the glass transformation temperature thereof.

One specific example of a toner, which was used in curing experiments included the following components:
1. Uralac P 3250 (saturated, carboxylated polyester resin) with 56% portion of total weight of the toner,
2. D.E.R.662E (cross-linking agent) with 44% portion of total weight of the toner, and
3. Color pigment with 4% portion of total weight of the toner (not used for clear toner).

Optionally, additives to control the melt flow, the surface quality, the toner charge, the powder flow, and if necessary, additional additives may be added as required.

The raw materials of such a toner may be mixed together and molten-mixed in a heated two-roller mill. The temperature of the roller and the mixture should be kept below 100° C. so that no significant cross-linking takes place in this production step. The cooled-off extrudate is milled to a particle size of ≧3 mm and then brought into a fluid-energy mill which pulverizes it further. Finally, the fine toner particles are classified to an average particle size of approx. 8 μm.

The above is only one example of a heat curable toner having polymer chains forming cross-links when heated above its glass transformation temperature, and other toners having different components may be used in combination with the apparatus and method described herein.

It is assumed that the carrier substrate when entering the fuser arrangement 30 (from the right) carries toner on at least the first (upper) side thereof, i.e. the side not contacting the transport belt. The toner may for example has been applied by the print modules 7 shown in FIG. 1. A typical speed for the transport belt 50 is about 15 cm/s or faster.

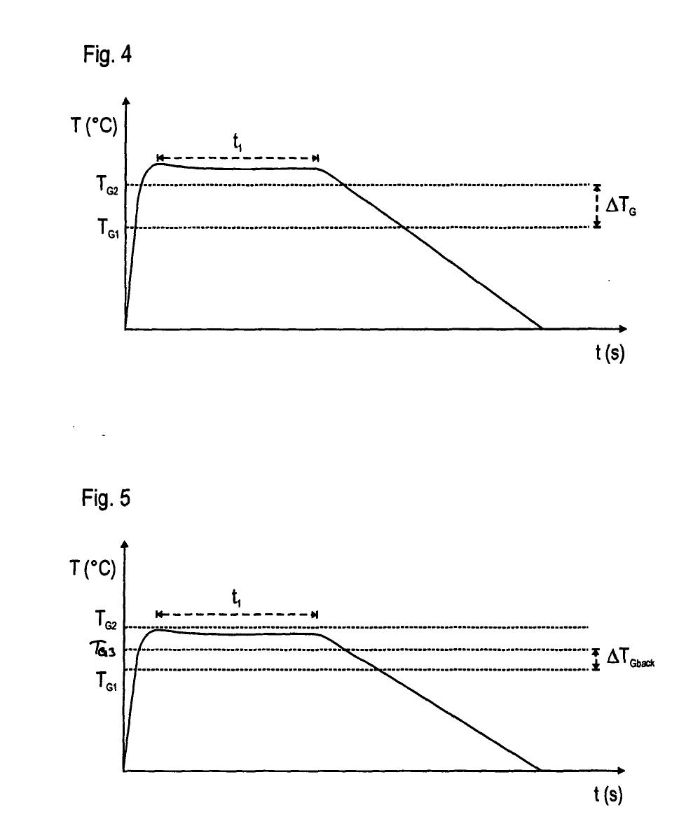

When the carrier substrate is moved along the first heat source 37, its temperature or at least the temperature of the toner is quickly heated to a temperature above the initial glass transition temperature T_{G1} of the toner. The toner may for example be heated to a temperature of about 100° C. or higher. The microwaves applied in the first heat source 37 allow an almost instant heating of the toner above its glass transition temperature, thus quickly initiating thermal cross linking within the toner. This effect may be clearly seen in FIG. 4.

After the carrier substrate and toner pass through the first heat source 37, they come to the second heat source 39, where sufficient heat is applied to keep the toner well above its glass transformation temperature for an extended period of time t₁ of at least one second and preferably up to several seconds. Due to this prolonged heating above the glass transformation temperature T_{G1}, a substantial amount of thermal cross linking (curing) can occur between the polymer chains of the toner, making the resulting toner layer more stable. The thermal cross linking in particular leads to a raised glass transition temperature of the toner as indicated by line T_{G2} in FIGS. 4 and 5. During the time t₁, the temperature of the toner may be kept approximately constant at about the temperature it was heated to in the first heat source 37. The temperature of the toner, however, may also be kept at a temperature above or below the temperature it was heated to in the first heat source 37 during the time t₁ as long as the temperature is above the glass transformation temperature of the toner to allow the thermal cross-linking to proceed. It is also not necessary to keep the temperature substantially constant during the time period t₁. The amount of heat provided by the heating mechanisms is controlled by a controller, to keep the toner temperature at the desired level. The amount of heat may also be controlled dependent on the speed of the transport mechanism 35.

The cross-linking of the polymer chains, may for example cause the glass transformation temperature of the toner to be raised by 5-10° C. or more to the second glass transformation temperature T_{G2}. The cross-linking will also cause an increase of the viscosity of the toner. It is preferred to achieve an increase in the glass transformation temperature of at least 5° C.

The thus cured toner images on the substrates showed significant improved mechanical and thermal stability and solvent resistance. Paper substrates having partially cured toner thereon are still deinkable in the papermaking process for recycling paper. This process can thus be used for printed-paper that will be collected for paper recycling.

After the carrier substrate and toner pass through the second heat source 39, they come to the first cooling arrangement 41, where the substrate carrier and/or the toner is actively cooled below the glass transition temperature of the toner. This may for example be achieve by bowing a gas, preferably air onto the top surface of the carrier substrate 2 and possibly also the inside surface of the transport belt 50.

Thereafter, the carrier substrate may exit the fuser arrangement 30. Additional cooling for the transport belt may be provided by the second cooling arrangement 42 at a location where no substrate transport occurs. Such additional cooling may be used to condition the transport belt to be able to provide a certain degree of cooling for the second side (i.e. the one contacting the transport belt 50) of the carrier substrate 2. Cooling of the second side of the carrier substrate 2 may be provided to protect the carrier substrate against overheating. The cooling could also be provided to cool any toner on the second side of the carrier substrate 2 below its glass transition temperature, which may higher than the glass transition temperature of the toner on the first side of the carrier substrate 2. This may be particularly advantageous in double sided printing, where a toner is applied and fixed to a first side of a carrier substrate 2 and then a toner is applied and fixed to the second side of the carrier substrate 2. When fixing the toner to the second side of the carrier substrate 2, the carrier substrate is in a reversed position inside the fuser arrangement 30, i.e. the previously first side is now the one which contacts the transport belt 50. If the toner applied on the first side of the carrier substrate 2 has been fixed thereto by the above method, it will have an increased glass transition temperature. Thus, by providing some cooling during the fixing of the toner on the second side of the carrier substrate 2, the toner on the first side may be kept below its glass transformation temperature. It is preferred that all of the toner on the first side of the carrier substrate 2 is kept at a temperature below its glass transition temperature. It is, however, possible that parts of the toner on the first side of the carrier substrate 2 are heated above its glass transition temperature. Subsequent cooling, however, may alleviate any problems associated with partial melting of the toner on the first side of the carrier substrate 2.

Such cooling may, for example, be provided by the transport belt 50, which may be cooled by any one of the cooling arrangements 41 to 43. Furthermore, the third cooling arrangement 43 may also be in a position to provide direct cooling of the side of the carrier substrate 2 contacting the transport belt. This may be the case when the transport belt allows the gas being blown onto the inside of the transport belt to contact the carrier substrate for example via perforations.

In an alternative example fixing of toner on the second side may be performed at a lower temperature than fixing of toner on the first side. This is for example identified in FIG. 5, where it is shown that the temperature is above the glass transition temperature T_{G1} of the toner on the second side but below the glass transition temperature T_{G2} of the toner on the first side, which has been previously cured by the method as described above and therefore has a higher glass transition temperature T_{G2}. Due to the lower fixing temperature, the toner on the second side is expected to have a lower glass transition temperature at the end of the fixing step (if the time for the fixing step is kept unchanged), as indicated by T_{G3}.

### INDUSTRIAL APPLICABILITY

The apparatus and the methods shown above may be used for fusing a heat curable toner to a carrier sheet having the toner placed thereon, to produce (at least partially) cured prints. Both simplex and duplex prints may be handled. The apparatus especially allows improved curing of heat curable toner to achieve a higher glass transformation temperature of the toner, thus leading to higher temperature stability of the print.

The invention has been described with respect to specific embodiments thereof without the intention to thereby limit the scope of the invention, which is defined by the appended claims.

1. A Method of fixing a heat curable toner to a carrier substrate, said method comprising the steps of:
heating the toner applied to a first surface of the carrier substrate above the glass transition temperature of the toner by microwave radiation, using at least one microwave applicator as a first heat source, to thereby initiate thermal cross-linking of polymer chains of said toner;
keeping the temperature above the glass transition temperature of the toner for a predetermined time of at least one second, by applying heat to the toner by means of at least one non-contact second heat source, to thereby allow the thermal cross-linking to proceed further and to thereby raise the glass transition temperature of the toner.

2. The method of claim 1, wherein at least one second heat source is a non-contact heat source.

3. The method of claim 1, wherein at least one second heat source is a microwave applicator.

4. The method of claim 1, wherein at least one second heat source is a source of IR-radiation.

5. The method of claim 1, wherein at least one second heat source comprises an oven chamber.

6. The method of claim 1, wherein at least one second heat source comprises a source of hot air.

7. The method of claim 1, wherein said toner is also UV curable and while the toner is kept at a temperature above its glass transition temperature, it is irradiated with UV-radiation.

8. The method of claim 7, wherein the UV-radiation is provided by a source of radiation which also provides IR-radiation to keep the temperature of the toner above its glass transition temperature.

9. The method of claim 1, wherein a second surface of the carrier substrate is cooled, while the toner applied to the first surface of the carrier substrate is kept above its glass transition temperature.

10. The method of claim 1, wherein the carrier substrate is transported along the first and second heat sources by a transport belt contacting a second surface of the carrier substrate.

11. The method of claim 9, wherein cooling of the second surface of the carrier substrate is provided via the transport belt.

12. The method of claim 9 to 11, wherein cooling of the second surface of the carrier substrate is provided by blowing a cooling gas onto the second surface of the carrier substrate and/or onto parts of the transport belt.

13. The method of claim 12, wherein the cooling gas is blown onto the second surface of the carrier substrate and/or the transport belt in an area opposite the second heat source.

14. The method of claim 12, wherein the cooling gas is ambient air.

15. The method of claim 14, wherein the ambient air is conditioned prior to being blown onto the second surface of the carrier substrate and/or the transport belt.

16. A method of double sided printing on a carrier substrate comprising the steps of
applying a heat curable toner on a first side of the carrier substrate;
fixing the toner to the first side of the carrier substrate in accordance with the method of any one of the preceding claims, thereby raising the glass transition temperature of the toner on the first side to a higher temperature value;
applying a heat curable toner on a second side of the carrier substrate;
fixing the toner to the second side of the carrier substrate in accordance with the method of any one of the preceding claims, wherein the toner fixed to the first side of the carrier substrate is in substance not heated above its glass transition temperature.

17. The method of claim 16, wherein the temperatures used while fixing the toner to the second side of the carrier substrate is below the temperature value of the glass transition temperature of the toner on the first side of the carrier substrate.

18. The method of claim 16, wherein the toner on the first side of the carrier substrate may be cooled while fixing the toner to the second side of the carrier substrate.

19. An apparatus for fixing a heat curable toner to a carrier substrate (2), said apparatus comprising:
at least one microwave applicator forming a first heat source;
at least one second heat source for heating the toner and/or the carrier substrate
at least one transport mechanism for contacting the carrier substrate on a second side thereof and for transporting the carrier substrate in sequence along the first and second heat sources;
at least one controller for controlling the first heat source, the second heat source and/or the transport mechanism such that toner on a first side of the carrier substrate is heated above its glass transition temperature and kept at a temperature above the glass transition temperature for at least one second.

20. The apparatus of claim 19, wherein said at least one second heat source is a non-contact heat source.

21. The apparatus of claim 19, wherein said at least one second heat source comprises a microwave applicator.

22. The apparatus of claim 19, wherein said at least one second heat source comprises a source of IR-radiation.

23. The apparatus of claim 19, wherein said at least one second heat source comprises an oven chamber.

24. The apparatus of claim 19, wherein said at least one second heat source comprises a source of hot air.

25. The apparatus of claim 19, comprising a source of UV-radiation in the vicinity or integrated within the second heat source.

26. The apparatus of claim 25, wherein the source of UV-radiation also provides IR-radiation.

27. The apparatus of 19, comprising cooling means for cooling the second side of the carrier substrate.

28. The apparatus of claim 19, wherein the transport mechanism comprises a transport belt contacting the second side of the carrier substrate.

29. The apparatus of claim 27, wherein the cooling means are arranged to cool the transport belt.

30. The apparatus of claim 19, wherein the cooling means comprise a source of a cooling gas and are arranged to blow the cooling gas onto the second side of the carrier substrate and/or onto parts of the transport belt.

31. The apparatus of claim 30, wherein the cooling means are arranged to blow the cooling gas onto the second surface of the carrier substrate and/or the transport belt in an area opposite the first/and or second heat source.

32. The apparatus of claim 30, wherein the cooling means comprise means for conditioning the cooling gas prior to being blown onto the second surface of the carrier substrate and/or the transport belt.
